(19) United States
(12) Patent Application Publication
(10) Pub. No.: US 2024/0310078 A1
(43) Pub. Date: Sep. 19, 2024

(54) CLEANING ROBOT FOR A SOLAR POWER PLANT

(71) Applicant: SOLARCLEANO S.À R.L., Grass (LU)

(72) Inventors: Christophe TIMMERMANS, Garnich (LU); Andreas KOKKAS, LUXEMBOURG (LU)

(21) Appl. No.: 18/575,438

(22) PCT Filed: Jun. 30, 2022
(86) PCT No.: PCT/EP2022/068046

§ 371 Date: Dec. 29, 2023

(30) Foreign Application Priority Data
Jul. 1, 2021 (LU) LU102836

(51) Int. Cl. F24S 40/20; A46B 13/00; A46B 13/02; B08B 1/12; B08B 1/34; B08B 1/40; H02S 40/10

(52) U.S. Cl. CPC F24S 40/20; A46B 13/001; A46B 13/02; B08B 1/12; B08B 1/34; B08B 1/40; H02S 40/10; A46B 2200/3073

(57) ABSTRACT

A cleaning robot (10) for cleaning solar collectors comprises a gantry-type frame (16) configured to span a row (14) of solar collectors (12) and to define a corresponding cleaning space (24); and wheels (28) that are fixed to the gantry frame in order to move the latter and are associated with drive means. A cleaning tool (30) extends across the width of the gantry and is able to move in the cleaning space in order to be positioned with respect to the upper surface of the solar collectors (12), the cleaning tool being guided by means of guide rails (40, 42) fixed to the frame. Actuating means (54, 56) are provided to move the cleaning tool along the guide rails. At least one distance sensor (64) is arranged to determine a distance between the cleaning tool and a respective solar panel. A control unit (70) is connected to the distance sensor(s) and is configured to, continuously, adjust the position of the cleaning tool with respect to the solar panels of a row. The frame (16) comprises two lateral uprights (18, 20) that are connected in their upper part by a transverse member (22), and one of the guide rails (40, 42) is fixed to each of the lateral uprights (18, 20). The cleaning tool (30) has, towards each of its ends, a respective guide element (44) which cooperates with an associated guide rail (40, 42). The two guide rails (40, 42) define a plane of movement for the cleaning tool (30) and one of the guide rails (42) is mounted in articulated manner on one of the lateral uprights (20) so as to be able to pivot in the plane of movement. The actuating means (54, 56) comprise, at the two ends of the cleaning tool, a respective linear actuator connected to the frame, an actuating rod (54.2, 56.2) of which is connected to the cleaning tool (30) and to the guide element (44), respectively.

### TECHNICAL FIELD

The present disclosure relates in general the field of cleaning solar collectors, and in particular to a cleaning robot for cleaning solar collectors.

### BACKGROUND

The solar industry is developing rapidly because as the sun is an infinite source of renewable energy and so provides a solution for reducing emissions.

Solar collectors generally take the form of panels, which are typically assembled in rows, for example on roofs or ground-mounted support tables (or similar). A distinction is generally drawn between photovoltaic solar collectors and thermal solar collectors.

A photovoltaic solar collector (also known as a photovoltaic module) generates electrical energy by converting sunlight. The photovoltaic module is composed of solar cells which are electrically interconnected.

Thermal solar collectors, also known as solar collectors or solar panels, are devices designed to collect solar energy transmitted by radiation and transfer it to a heat transfer fluid (gas or liquid) in the form of heat. Also taking the form of panels, they are frequently mounted on roofs and used to produce domestic hot water or heating.

At the industrial level, there are photovoltaic solar power plants, in which the photovoltaic modules are arranged in fields which comprise a plurality of parallel lines or rows of photovoltaic modules.

It is important to clean the surface of these solar collectors to ensure they remain efficient.

For rooftop solar collectors, cleaning can be done manually (operator with broom and water jet on the roof). When the slope of the roof and/or the area of the solar collectors increases, it is possible to use an articulated arm with a brush (if the roof is not too high) or remote-controlled tracked robots (see for example WO 2020/200694 A1) which move over the panels.

In the case of industrial installations of the power plant or solar farm type, which comprise large arrays of ground-mounted panels, cleaning may be carried out by brush devices which move over the rows of solar collectors, guided by rails placed on the panels and/or their edges. Such devices are known for example from DE 10 2010 025 845 A1.

Other brush devices are known, for example, from WO 2016/006246 A1. In one such device, the brush is brought into contact by application of force with the surface of the solar panel to be cleaned and pressed against it with the assistance of springs. The resultant pressure can damage the solar panels.

It is also possible to make use of vehicles travelling on the ground between the rows of solar collectors which are equipped with cleaning means. EP 2 567 758 describes, for example, a cleaning assembly comprising a brush fixed to a hydraulically operated articulated arm which is intended for mounting on an agricultural machine such as a tractor.

Driving such a machine is complex because the arm is controlled by the driver who is located beside the row and has to estimate the orientation/inclination of the brush and its distance from the surface of the solar collectors.

A plurality of points are critical in this respect. The brush-to-panel distance must be kept under control so that the pressure applied to the panels does not damage them. The inclination of the brush is also important because the brush must be fully parallel to the plane of the panels to provide a uniform pressure and ensure that the row of panels is cleaned across its entire width. In this respect, the solution proposed by EP 2 567 758 would appear to be riskier since any bumpiness of the ground between the rows will result in major movements of the brush (lever arm). The same applies to the solution proposed by US 2020/164414 A1, which also describes a cleaning assembly comprising a brush fixed to a hydraulically operated articulated arm mounted on a vehicle.

### BRIEF SUMMARY

The disclosure provides a vehicle with an improved design which enables effective and safe control of the cleaning tool and is specifically designed to move within solar power plants.

The disclosure relates to a cleaning robot for cleaning solar collectors comprising:
a gantry-type frame configured to span a row of solar collectors and define a corresponding cleaning space;
wheels that are fixed to the gantry in order to move the latter and are associated with drive means;
a cleaning tool extending across the width of the gantry and able to move in the cleaning space in order to be positioned with respect to the upper surface of the solar collectors, the cleaning tool being guided by means of guide rails fixed to the frame;
actuating means to move the cleaning tool along the guide rails;
at least one distance sensor arranged to determine a distance between the cleaning tool and a respective solar panel;
a control unit connected to the distance sensor(s) and configured to adjust the position of the cleaning tool with respect to the solar panels of a row by way of the actuating means,
wherein:
the frame comprises two lateral uprights that are connected in their upper part by a transverse member, one of said guide rails being fixed to each of the lateral uprights,
the cleaning tool has towards each of its ends a respective guide element which cooperates with an associated guide rail,
the two guide rails define a plane of movement for the cleaning tool and one of the guide rails is mounted in articulated manner on one of the lateral uprights so as to be able to pivot in the plane of movement, and
the actuating means comprise, at the two ends of the cleaning tool, a respective linear actuator connected to the frame, an actuating rod of which is connected to the cleaning tool and to the guide element, respectively.

The disclosure thus proposes a gantry-type cleaning robot capable of spanning solar collectors, in particular a row of solar collectors. The cleaning tool, in particular of the brush type, moves within the robot's cleaning space in which the panel(s) are located. The use of distance sensors makes it possible continuously or virtually continuously (i.e. in real time) to adjust the distance of the cleaning tool from the upper face of the solar panels to be cleaned when the cleaning tool is in motion. The cleaning tool is therefore normally maintained at a predetermined distance from the surface of the solar panels.

According to the disclosure, the actuating rod of a linear actuator is connected to the cleaning tool either directly or indirectly by way of the guide element. The presence of respective linear actuators at the two ends of the cleaning tool allows independent control of each side of the cleaning tool, so enabling different lengths of movement at each end of the cleaning tool, in order to adapt the angle of the latter to the inclination of solar panels to be cleaned.

The design of the robot according to the disclosure is particularly advantageous in comparison with known solutions, in particular in comparison with tractors with a hydraulic brush described in EP 2 567 758:
the gantry configuration makes it possible to span the panels to be cleaned. The cleaning tool can thus be supported under the gantry, so avoiding overhangs and improving the accuracy of maneuvering;
the gantry configuration reduces the footprint of the robot which can travel in narrow inter-row spaces. For example, the present robot can travel in an inter-row spacing of the order of 60 cm, whereas a tractor requires a spacing of 3 m between rows of solar panels;
the position of the cleaning tool is adjusted automatically thanks to the sensors;
the structure with guide rails on either side of the cleaning tool enables robust vertical guidance.

Although the present cleaning robot was developed for cleaning photovoltaic solar collectors having a planar surface exposed to the sun, this robot can be applied to all types of solar collectors, whether photovoltaic or thermal, flat or dished, subject if needs be to any adjustments to dimensions and/or the cleaning tool.

The lateral uprights and transverse member are preferably of open-work construction to limit weight. They may be made from all types of elements such as for example beams, profiles and tubes. These elements may be made of metal, in particular aluminium alloy or steel, or of composite.

The cleaning tool is advantageously of the brush type and may have one or more brushes configured to extend across the width of the gantry.

The cleaning tool preferably comprises at least one rotary brush extending across the width of the gantry along a first axis.

According to some variants, the rotary brush is a cylindrical brush having a central shaft parallel to, or concentric with, the first axis, and is driven in rotation about the central shaft. The cylindrical brush has a predetermined length appropriate to the width of the row to be cleaned. The cylindrical brush may be composed of one or a plurality of sections. When the brush has a plurality of brush sections, the brush bristles are preferably arranged to cover junction zones between two adjacent brush sections.

In some variants, the cleaning tool comprises a second cylindrical rotary brush, the central shaft of which is parallel to the first axis and offset from the latter, said other brush being driven in rotation about its central shaft. The two cleaning brushes are thus arranged side by side, i.e. one behind the other in the cleaning direction.

Other brush cleaning tool configurations may be considered. For example, according to another variant, a plurality of axial rotary brushes are fixed to a supporting cross-piece extending across the width of the gantry. The radial brushes are arranged side by side so as to cover the width of the gantry. Each axial rotary brush has an axis of rotation which extends substantially perpendicular to the supporting cross-piece and therefore, when in use, to the surface of the solar panels to be cleaned.

The brushes have bristles/fibres made from any material appropriate for cleaning solar panels, for example from nylon, microfibres or foam.

The exemplary embodiment presented here relates to cleaning planar solar panels, such that the brush has zero curvature between its two ends. The cleaning robot according to the disclosure may, however, readily be adapted to cleaning all types of solar sensor, for example cylindrical parabolic thermal solar collectors, and in this case the brush has between its ends an external profile corresponding to the curvature of the solar collector to be cleaned, so as to ensure brush contact over the entire surface to be cleaned and consequently uniform cleaning of the solar collector.

In other embodiments, the cleaning tool may comprise any other configuration of brushes, squeegees and/or cloths extending across the width of the gantry which are appropriate for cleaning the surface of the solar collectors.

In some variants, the robot further comprises means for spraying washing liquids, for example water. These spraying means may comprise jets or nozzles fixed to the gantry or directly on the cleaning tool in order to spray jets of cleaning liquid, or spray, towards the solar collectors. In this case, the robot comprises one or more water tanks, spray nozzles and a distribution circuit with pump connecting the tanks to the nozzles.

Depending on the variant, the linear actuators may have any form/configuration appropriate for guiding the cleaning tool; in particular their rods may be oriented in the same or opposite directions.

In some variants, a guide element comprises a guide part by which it is secured to the guide rail, and a connecting part fixed in articulated manner to one end of the cleaning tool. The actuating means is preferably connected to this guide element.

In some variants, the guide means may comprise actuators fixed to the frame, for example in the upper part, in particular on the transverse element, and cable and pulley systems, or chain or rack systems, connecting the actuators to the guide elements.

The cleaning robot according to the disclosure comprises at least one distance sensor which is arranged to determine the distance between the brush and the surface of the panels to be cleaned. According to preferred embodiments, the cleaning robot comprises two, four or six distance sensors, enabling more precise determination of the brush's position and its orientation with respect to the surface of the solar panels. The distance sensors are preferably mounted on the brush support structure which moves integrally with the brush under the action of the actuating means, therefore close to the rotary brush itself. The distance sensors typically measure the distance in the substantially vertical direction, therefore essentially at right angles to the position of the rotary brush.

The orientation of the cleaning tool may be controlled by two distance sensors placed at each end of the cleaning tool in order to detect the edge regions of the row.

Preferably, the sensors are arranged in pairs, one sensor being positioned on the front of the brush and one sensor being on the back (relative to the direction of movement). The front of the brush corresponds to the side of the brush facing the dirty surface to be cleaned and the back of the brush corresponds to the side of the brush facing the cleaned surface. The robot can thus function in two directions. The sensors also make it possible to detect the end of a row or a space between the panels in a row.

Advantageously, a pair of sensors is arranged at each end of the brush. Depending on the type of solar installation to be cleaned, for example in the case of cleaning solar trackers supporting conventional solar panels, it is also advantageous to equip the brush with a third pair of sensors arranged in the middle of the brush along its length, which make it possible to detect any excess thickness located in the middle (in the direction of the width of the gantry) of the tracker and so to lift the brush at that point.

The solar collectors arranged in rows in the solar collector installation are not necessarily in contact with one another, such that a free space may be formed, in the X direction, between two adjacent panels in the same row. The control unit is advantageously configured to evaluate the sensor signal such that this space is recognised as such and the brush is not lowered.

Any known type of distance sensor may be used as the distance sensor according to the disclosure, in particular sensors of the LIDAR type or ultrasound transmitter and detector type or alternatively of the video camera type. When the cleaning robot comprises more than one position sensor, the various sensors may be identical or different from one another.

### BRIEF DESCRIPTION OF THE FIGURES

Other details and features of the disclosure will emerge from the following detailed description of at least one advantageous embodiment, provided below by way of illustration with reference to the appended drawings, in which:

FIG. 1 is a perspective view of an embodiment of a cleaning robot according to the disclosure;

FIG. 2 is a front view of the cleaning robot of FIG. 1;

FIG. 3 is a side view of the cleaning robot of FIG. 1;

FIG. 4 is a close-up view of the right-hand upright of the cleaning robot of FIG. 1;

FIG. 5 is a perspective view of the brush mounted in is support frame;

FIG. 6: is a detail, perspective view of the rail pivoting in the slideway; and

FIG. 7: is a detail view from above of the guide element on the guide element on the vertical rail.

### DETAILED DESCRIPTION

The present disclosure will be described on the basis of an example of application to cleaning robots for cleaning planar solar panels, such as photovoltaic panels with a planar surface exposed to the sun.

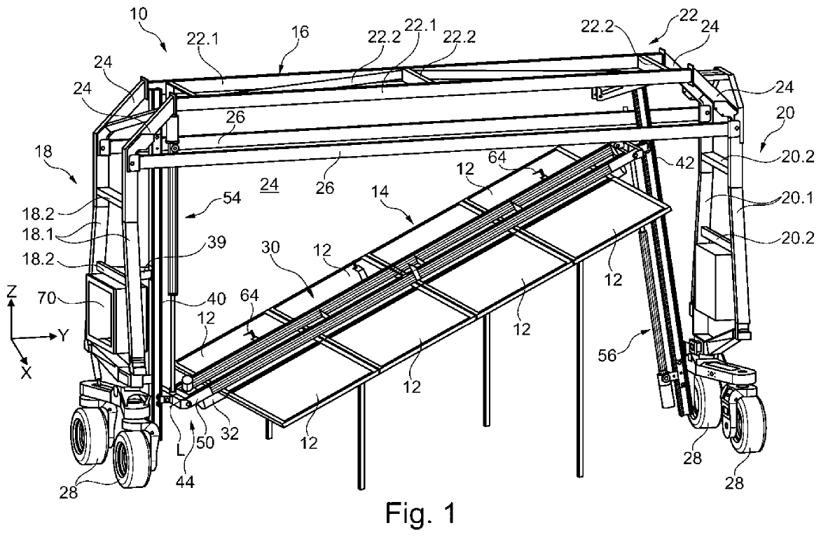

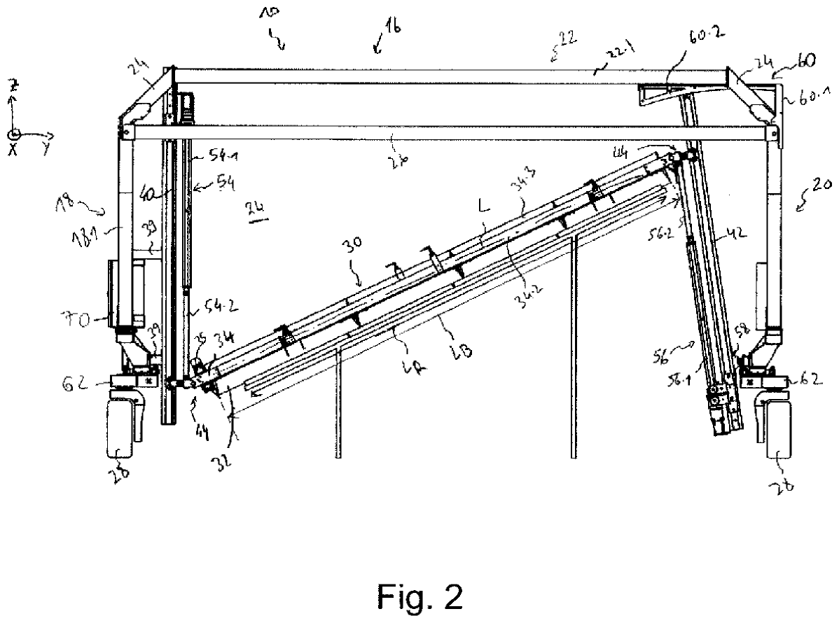

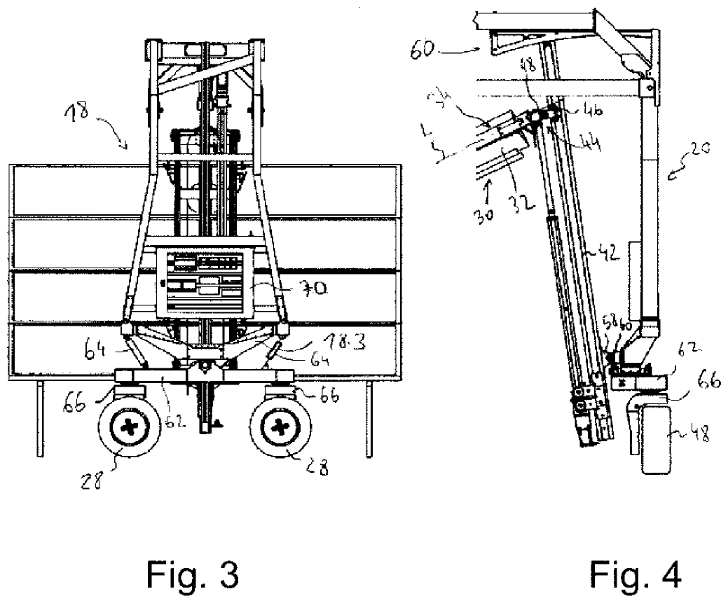

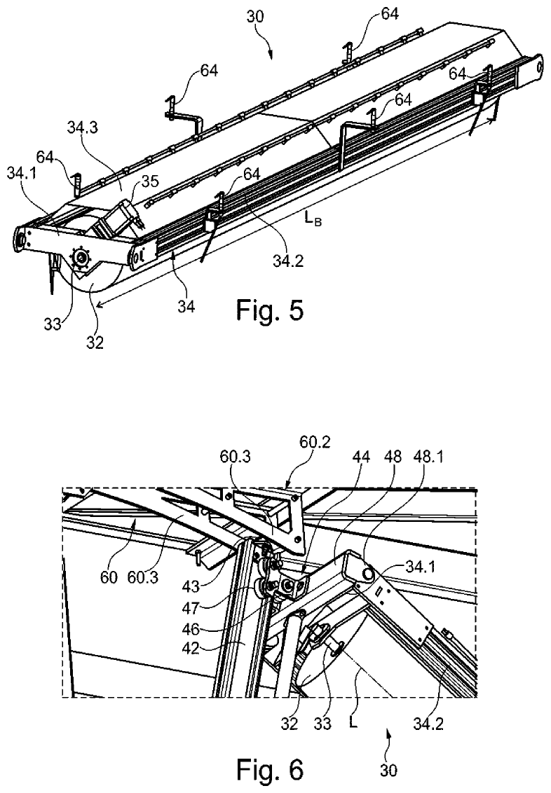

FIG. 1 shows a perspective view of a cleaning robot 10 for solar collectors according to one embodiment of the present disclosure.

The solar collectors 12 (or solar panels) are generally arranged in rows parallel to each other and are anchored to the ground. The ground supporting the solar collectors 12 defines a horizontal plane with respect to the orientation of the drawings, i.e. a plane (X, Y) with reference to the right-handed Cartesian coordinate system shown on the drawing for ease of explanation. On FIG. 1, the solar panels 12 are aligned to form rows in the X direction and the cleaning robot moves in this X direction when cleaning the solar panels 12. The row 14 is illustrated symbolically with only two sets of four panels being shown here. In practice, a row has numerous sets of four panels arranged end-to-end in the X direction.

The robot 10 comprises a gantry-type frame 16 (in the general shape of an inverted U) comprising two lateral uprights 18, 20 that are connected in their upper part by a transverse member 22. The space between the lateral uprights 18, 20 and the transverse member 22 constitutes a cleaning space 24, by way of which the robot 10 will, when in use, span a row 14 of solar collectors. It will be noted that the XYZ coordinate system is defined relative to the robot 10 and therefore comprises three axes perpendicular to each other, namely the horizontal X axis, parallel to the ground and corresponding to the general direction of movement of the robot 10 along the row of solar panels; the horizontal transverse Y axis, likewise parallel to the ground and perpendicular to the X axis, along which the transverse member 22 extends; and the vertical Z axis, perpendicular to the ground and to the horizontal X, Y plane.

In general, the dimensions of the frame 16, in particular its height Hp in the Z direction and its width Lp in the Y direction, are defined depending on the characteristics of the solar panels 12 to be cleaned, and the inter-row space, such that the frame can span the solar panels with a certain margin of manoeuvre.

The various elements of the frame 16, in particular the lateral uprights 18, 20 and the transverse member 22 are typically made from profiles, tubes (of rectangular or other cross-section) and/or beams, assembled by any appropriate means, in particular rigidly, for example by welding, screwing and/or riveting.

In the present variant, the lateral members 18, 20 comprise outer tubes 18.1, 20.1 extending generally in the vertical direction and connected by cross-pieces 18.2, 20.2. The transverse member 22 comprises two parallel tubes 22.1 which join the upper parts of the lateral uprights 18, 20. Perpendicular or oblique cross-pieces 22.2 connect the two parallel tubes 22.1 for reinforcement. The ends of the parallel tubes 22.1 are connected to the outer tubes 18.1, 20.1 by inclined connecting pieces 24. Two horizontal reinforcement tubes 26 connect the opposing outer tubes in pairs at the base of the connecting pieces.

The lateral members 18, 20 and the transverse member 22 are made as independent (preassembled) elements and these three main elements are then assembled. Connection can be made by any appropriate means, for example welding, screwing, riveting, etc. The use of removable fasteners such as bolts facilitates disassembly. Ease of disassembly is of particular interest in some variants, not shown here, where several cross-members of different lengths are available. This makes it possible to change the transverse member to adapt the width of the cleaning robot to the width of the solar panels to be cleaned and to the distance between rows of solar panels. Another alternative (not shown) involves using a telescopic transverse member with telescopic tubes.

The cleaning robot 10 moves over the ground by means of wheels 28 that are fixed at the lower part of the lateral uprights 18, 20 and are associated with drive means. In the variant, two wheels 28 are fixed under each upright 18, 20 and aligned in the direction of movement (X axis). These wheels are advantageously pivotable by 360° and at least one, preferably both, are angularly adjustable drive wheels. These sets of wheels enable the robot 10 to move autonomously within the installation of solar panels to be cleaned, in particular along a row of solar panels, and to manoeuvre between the rows.

The use of wheels 28 pivotable by 360° facilitates maneuvering of the cleaning robot, in particular when it reaches the end of a row of solar collectors. Thanks to the pivotable wheels, the robot does not have to make a U-turn at the end of a row in order to position itself for cleaning the next row, but can instead simply move in the Y direction from one row to the next. The cleaning robot 10 according to the disclosure can therefore be used to clean solar collector installations which have little or no free space (i.e. without solar collectors) at the end of row to allow the robot to make a U-turn.

It will be understood that the cleaning robot 10 comprises a cleaning tool 30 arranged in the cleaning space 24 of the robot 10. The cleaning tool 30 is elongate, extending along an axis L across the width of the gantry, and is able to move in the cleaning space, i.e. generally in the vertical direction.

In the present embodiment, the cleaning tool 30 has a cylindrical brush 32, the central shaft 33 of which is parallel to or concentric with the axis L. The brush 32 rotates about its central shaft 33. The present brush 32 has a length L_{B} along the axis L in the widthwise direction of the gantry. The brush length L_{B} at least corresponds to the width L_{R} of a row 14 of solar panels to be cleaned.

Any type of brush may be used, for example a nylon brush or a microfibre brush, depending on the type of cleaning to carried out, for example on the type of soiling on the solar panels, or the frequency of cleaning. The brush can also be used to remove a layer of freshly fallen snow from the panels to permit generation. The bristles may be straight or helical.

The brush 32 may be a cylindrical brush formed in a single part (single section), or may be composed of a plurality of brush sections arranged one after the other in the direction L. In the first case, a tube core having the desired brush length bears the brush bristles which extend substantially radially. In the case of a brush in multiple sections, the brush bristles are set in place such that they also extend over the joints between the brush sections. Thus, when the brush is composed of a plurality of brush sections, it has a cylindrical surface uniformly covered with brush bristles, such that the entire width of the solar collector in the widthwise direction of the gantry solar is in contact with brush bristles so that the surface is uniformly cleaned.

In practice, the cylindrical brush 32 is mounted in a support frame 34 which comprises two end pieces 34.1 supporting the brush's rotary shaft 33, the end parts being connected by lateral profiles 34.2. A protective casing 34.3 fixed to the frame 34 covers the top of the brush 32.

An electric motor 35 is integral with the frame 34 and coupled to the brush shaft 33. The electric motor 35 allows the brush to be selectively driven in rotation.

The cleaning tool may optionally comprise a second cylindrical brush (not shown), the axis of rotation of which is parallel to, but offset from, the axis of rotation of the brush 32. The second brush is of the same length as the first and of identical or similar design. The second brush may also be mounted in the support frame (the dimensions of which can be adapted).

The brushes may be identical or different, for example having a different external diameter or be composed of bristles of a different type, for example to enable first rough cleaning of the surface with the assistance of the first brush and finishing with the assistance of the second brush.

The cleaning tool 30 is guided in the cleaning space 24 by guide rails 40, 42 fixed to the frame 16. More specifically, a straight guide rail 40, 42 is fixed to the inner side of each of the lateral uprights 18, 20 in a substantially vertical direction. The rail 40 is fixed to the lateral upright 18 by two supports 39. The cleaning tool 30 is connected at each of its two ends to one of the guide rails 40, 42 by way of a guide element 44.

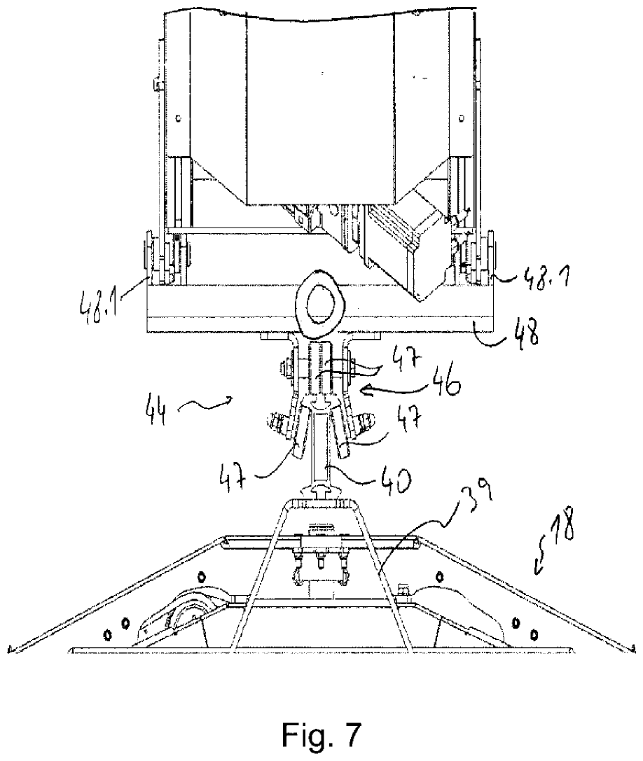

As is more clearly visible in FIG. 7, the guide element 44 comprises a guide part 46, capable of moving linearly along the guide rail 40, 42, and a connecting part 48, fixed in articulated manner to the support frame 34 of the cleaning tool 30.

The guide part 46 is attached to the guide rail by means of a (translational) slideway type connection. For example, the rail may be a hollow profile in which the guide part slides. Alternatively, as is the case here, the guide part 46 may be embodied in the manner of a carriage with contact rollers 47 which complementarily grip part of the rail profile (for example a rail part of a T-shape or other appropriate shapes).

The connecting part 48 is rigidly connected to the guide part 46 and here takes the form of a stirrup, the lateral legs 48.1 of which are pivotably attached to the ends 34.1 of the support frame 34 of the brush 32.

Two linear actuators 54, 56 are arranged on either side of the cleaning tool 30 along the guide rails 40, 42. The actuator, of the electric screw jack type, has a body 54.1, 56.1 fixed on the one hand to a respective guide rail and an actuating rod 54.2, 56.2 fixed to a guide element 44.

A movement of an actuator 54, 56 causes the guide element 44 to which it is connected to move on the corresponding guide rail and so causes the end of the brush to move. The movement of the actuator is thus transmitted to the cleaning tool 30 by way of the guide element 44, which is connected to the actuator 54, 56, to the guide rail 40, 42 and to the cleaning tool 30.

The actuators 54, 56 enable independent control of each side of the cleaning tool 30, allowing different lengths of movement at each end of the cleaning tool, in order to change the brush angle (angle between L and Z axes).

It will be noted that the two actuators 54, 56 are arranged in opposition to one another. The screw jack 54 (on the left) is fixed to the upper part the rail 40 and has its actuating rod 54.2 pointing downwards (parallel to the rail) to move the left-hand part of the cleaning tool 30 in the lower part of the cleaning space 24. The screw jack 56 (on the right) is fixed at the lower part of the rail 42 and has its actuating rod pointing upwards (parallel to the rail 42) to move the other end of the cleaning tool 30 in the upper part of the cleaning space. Such a configuration is desirable for cleaning inclined solar panel assemblies.

In the case of flat panels, the two screw jacks 54, 56 can be installed with the rod pointing downwards, as for screw jack 54.

The actuators 54, 56 are fixed by any appropriate means, in particular by screwing. Means may be provided to fix the actuator body 54.1, 56.1 at different locations along the rail, so providing additional adjustment flexibility. It will also be noted that the actuators may also be fixed on the upper part of the robot 10 in order to increase the amplitude travel on the rails.

One of the rails, in this case rail 42, is mounted pivotably in order to allow the angle of the cleaning tool 30 to be varied.

In the variant illustrated, the rail 42 is connected pivotably at its lower end to the lateral upright 20 of the frame by way of a pivot connection about a connecting axis extending in the X direction. The pivot connection may be obtained in any appropriate manner, for example a bracket 58 fixed to the rail 42 is connected by a pin (bolt) to another bracket or clevis 60 fixed to the lateral upright 20.

The upper end of the rail 42 cooperates with a guide support 60 fixed to the transverse member 20. The guide support 60 has a fixing part 60.1 from which extends a slideway 60.2 configured to guide the upper end of the rail 42. Movement of the rail 42 in the X direction is therefore limited by the slideway 60.2, which does, however, allow the rail 42 to move about its pivot in the plane (X, Y), i.e. in the slideway 60.2. The curvature of the slideway 60.2 is adapted to follow the movement of the rail. In the variant, the slideway 60.2 comprises two open-work sidewalls with lower edges 60.3 between which slide a pair of rollers 43 fixed to the end of the rail 42.

Alternatively the slideway may be embodied by a beam (e.g. T-shaped) and the end of the guide rail may be equipped with a carriage which grips a complementary shape of the beam (e.g. the T-shaped part).

The wheels 28 are mounted in pairs on an arm 62 fixed pivotably at its centre to an upright 20, 22. The arm 62, which forms a kind of axle, thus extends in the X direction, and the two wheels 28 are mounted one behind the other in the direction of movement, one at each end of the arm 62. More specifically, each lateral upright 18, 20 comprises a generally V-shaped lower cross-piece 18.3. The arm 62 is fixed pivotably at its centre, articulated on the central part of the lower cross-piece 18.3. This therefore allows the arm 62 to move in the direction of travel of the robot 10 depending on the bumpiness of the ground. The arm 62 is advantageously stabilised by two shock absorbers 64, each of which connects a lower end of the lateral upright 18 to a corresponding arm part.

The wheels 28 are supported by a bracket 66 which comprises a vertical shaft (not shown) allowing the wheel to pivot by 360° and a horizontal shaft (not shown) supporting the hub of the wheel.

Means (not visible) are integrated to drive the wheels 28 and steer them (wheel angle control). Any drive and control system may be used. The wheels may be equipped with integrated motors. Angle control can be integrated to the axle arm 62. Alternatively, drive control of the wheels may be performed in the manner described in WO 2020/192806.

Reference sign 70 denotes a control unit. The control unit 62 is configured to manage the various functions of the robot, in particular to manage the cleaning tool 30, i.e. both the rotation of the brush 32 (by way of control of the motor 35) and its movement in the cleaning space 24 (by way of operation of the actuators 54, 56). It is therefore connected, in wired or wireless manner, to the actuators 54, 56 and to the brush motor. To adjust the position of the cleaning tool in the cleaning space, the control unit further receives measurement signals from a plurality of distance sensors 64 arranged on the cleaning unit 30. The distance sensors 64 make it possible to measure the distance between the cleaning tool 30 and the panel 12.

In the present variant, six sensors 64 are arranged in pairs along the length of the tool 30. Each sensor 64 therefore determines the distance between the tool 30 and the panel 12 at the level at which it is located. The distance is measured substantially in line with each sensor. The control unit 70 is thus configured to control the orientation of the cleaning unit, primarily on the basis of the signals from the sensors 64 at the ends. The control unit further uses the signals from the sensors 64 to keep the brush at a predetermined distance (or range of distances) from the panels. This distance may in particular be calibrated such that the pressure exerted by the brush does not exceed a predetermined threshold, for example of the order of 3000 to 5000 Pa.

The sensors 64 may be based any kind of telemetry technology, for example based on ultrasound or light beams, in particular LIDAR or ultrasound sensors. They are connected in wired or wireless manner to the control unit 70.

The control unit 70 is also advantageously configured to manage the movement of the robot 10 by way of controlling the wheels 28.

In general, the control unit 70 may be a microprocessor system comprising various items of hardware and software implementing the above-mentioned functionalities and control principles. The control unit 70 is typically powered by a battery (not shown), which also powers the drive means of the wheels 28 and is preferably rechargeable by solar panels (not shown) mounted on the robot 10.

The control unit 70 further comprises wireless communication means capable of receiving and transmitting data on at least one communication network.

Communication may be effected by way of a protocol such as wifi, cellular (3G, 4G, 5G), Bluetooth, or their equivalents. It this way, the robot's status can be determined remotely and its operating parameters modified with regard to brush control and/or the robot's route.

1. A cleaning robot for cleaning solar collectors comprising:
a gantry-type frame configured to span a row of solar collectors and define a corresponding cleaning space;
wheels that are fixed to the frame in order to move the latter and are associated with drive means;
a cleaning tool extending across a width of the frame and able to move in the cleaning space in order to be positioned with respect to an upper surface of the solar panels, the cleaning tool being guided by means of guide rails fixed to the frame;
actuating means to move the cleaning tool along the guide rails;
at least one distance sensor arranged to determine a distance between the cleaning tool and a respective solar collector;
a control unit connected to said at least one distance sensor and configured to adjust the position of the cleaning tool with respect to the solar collectors of a row by way of the actuating means;
wherein:
the frame comprises two lateral uprights that are connected in their upper part by a transverse member, one of said guide rails being fixed to each of the lateral uprights,
the cleaning tool has towards each of its ends a respective guide element which cooperates with an associated guide rail,
the two guide rails define a plane of movement for the cleaning tool and one of the guide rails is mounted in articulated manner on one of the lateral uprights so as to be able to pivot in the plane of movement, and the actuating means comprise, at the two ends of the cleaning tool, a respective linear actuator connected to the frame, an actuating rod of which is connected to the cleaning tool and to the guide element, respectively.

2. The cleaning robot according to claim 1, wherein the cleaning tool comprises at least one rotary brush extending across the width of the frame along a first axis.

3. The cleaning robot according to claim 2, wherein the rotary brush is a cylindrical brush having a central shaft parallel to, or concentric with, the first axis, and is driven in rotation about the central shaft.

4. The cleaning robot according to claim 2, comprising another cylindrical rotary brush, the central shaft of which is parallel to the first axis and offset from the latter, said other brush being driven in rotation about its central shaft.

5. The cleaning robot according to claim 3, wherein the cylindrical brush has a predetermined length and is composed of a single section or a plurality of sections.

6. The cleaning robot according to claim 1, wherein the cleaning tool comprises a plurality of axial rotary brushes fixed to a cross-piece extending across the width of the gantry, the brushes of the plurality of brushes being arranged so as to cover the width of the gantry.

7. The cleaning robot according to any one of claim 1, wherein the guide elements comprise a guide part, capable of moving linearly along the guide rail, and a connecting part fixed in articulated manner to a support frame of the cleaning tool.

8. The cleaning robot according to claim 1, wherein the guide rail mounted in articulated manner is fixed pivotably at one end; and the opposite end cooperates with a guide support which has a curvature shaped to accompany the guide rail end during pivoting.

9. The cleaning robot according to claim 1, wherein the linear actuators are mounted on each of the guide rails, in adjustable manner along the guide rail.

10. The cleaning robot according to claim 1, wherein a linear actuator is fixed at the lower part of the rail with its actuating rod directed upwards; and the other linear actuator is fixed at the upper part of the rail with its actuating rod directed downwards.

11. The cleaning robot according to claim 1, wherein the two linear actuators are fixed at the upper part of the frame, in particular to the rails, and have their respective actuating rod facing downwards.

12. The cleaning robot according to claim 1, wherein the linear actuators are fixed horizontally at the upper part of the frame, the actuating rods moving horizontally and being connected, in particular by flexible links and pulleys, to the cleaning tool and to the guide element respectively.

13. The cleaning robot according to claim 1, wherein said at least one distance sensor comprises a LIDAR, an ultrasound transmitter and detector system, or a video camera.

14. The cleaning robot according to claim 1, wherein the solar collectors are selected from photovoltaic solar collectors and thermal solar collectors.

15. The cleaning robot according to claim 1, wherein the wheels are pivotable by 360° and at least one wheel on either side of the frame is a drive wheel.

16. The cleaning robot according to claim 1, wherein the control unit is further configured to control the drive wheels and to move the cleaning robot along a predetermined route of solar collectors to be cleaned.

17. The cleaning robot according to claim 1, wherein two wheels are mounted supported under each lateral upright by an axle arm, the arm being fixed pivotably at the lower part of the lateral upright.

18. The cleaning robot according to claim 1, wherein a respective shock-absorbing device connects the arm to the lateral upright on either side of the pivot point.

19. The cleaning robot according to claim 1, further comprising an electric power source, preferably a battery, in particular a rechargeable battery coupled to photovoltaic panels carried by the frame.

20. The cleaning robot according to claim 1, comprising a tank of washing liquid, in particular water, and jets nozzles installed on the frame and/or on the cleaning tool, fed by means of a distribution circuit.
